(19) United States
(12) Patent Application Publication
(10) Pub. No.: US 2013/0240753 A1
(43) Pub. Date: Sep. 19, 2013

(54) Ion Source and Ion Implanter Including the Same

(71) Applicant: SAMSUNG ELECTRONICS CO., LTD., Gyeonggi-do (KR)

(72) Inventor: Seiji Kamei, Gyeonggi-do (KR)

(73) Assignee: Samsung Electronics Co., Ltd., Suwon-si (KR)

(21) Appl. No.: 13/660,489

(22) Filed: Oct. 25, 2012

(30) Foreign Application Priority Data
Mar. 14, 2012 (KR) 10-2012-0026202

(51) Int. Cl. H01J 27/20; G21K 5/04

(52) U.S. Cl. 250/427; 250/492.21

(57) ABSTRACT

An ion source includes a filament configured to emit thermoelectrons and a cathode having a first side proximate the filament and a second side opposite the first side. The cathode includes a first layer that includes a first material on the first side of the cathode and a second layer on the second side of the cathode. The first layer is between the filament and the second side. The second layer is configured to limit discharge of the first material of the first layer from the ion source when the filament emits themoelectrons to generate ions from the ion source

### CROSS-REFERENCE TO RELATED APPLICATIONS

This application claims the benefit of Korean Patent Application No. 10-2012-0026202, filed on Mar. 14, 2012, in the Korean Intellectual Property Office, the disclosure of which is incorporated herein in its entirety by reference.

### BACKGROUND

The inventive concept relates to an ion source and an ion implanter including the ion source, and more particularly, to an ion source including a cathode for emitting electrons for ionization and an ion implanter including the ion source.

Generally, an ion implantation method is used to add dopants to a semiconductor wafer. The principle of the ion implantation method is that an ion implanter accelerates ions and then implants the accelerated ions, in the form of beam, into a semiconductor wafer on which an ion implantation mask has been formed. Normally, the amount of dopants to be implanted is determined according to the size of dopant atoms, an acceleration speed of ions, and a time during which a semiconductor wafer is exposed to an ion implantation beam. Typical, ion implantation processes that are mainly used in semiconductor device manufacturing processes include an impurity implantation process for forming a diode and source/drain regions in a substrate, an impurity implantation process for providing conductivity when depositing polysilicon to form a gate electrode, and an impurity implantation process for increasing a threshold voltage.

### SUMMARY

Some embodiments of the present invention provide an ion source including a filament configured to emit thermoelectrons and a cathode having a first side proximate the filament and a second side opposite the first side. The cathode includes a first layer that includes a first material on the first side of the cathode and a second layer on the second side of the cathode. The first layer is between the filament and the second side. The second layer is configured to limit discharge of the first material of the first layer from the ion source when the filament emits themoelectrons to generate ions from the ion source.

In further embodiments, the first layer is heated by the thermoelectrons that are emitted from the filament and the second layer emits secondary electrons responsive to energy transmitted from the first layer when the first layer is heated by the thermoelectrons.

In other embodiments, the second layer includes a second material that is different from the first material. The first material may be a metal and the second material may be a nonmetallic material. The second material may include at least one of carbon, black lead, graphite and a high melting point material. The second material may include at least one of carbon, black lead and graphite.

In further embodiments, the second material is a nonmetallic material that has a melting point of at least 3000° C. The first material may be a high melting point metal that has a melting point of at least 2000° C.

In other embodiments, an ionization energy of the second material is larger than an ionization energy of the first material.

In other embodiments, the second material is a material that generates a shallow-level trap in silicon compared to a trap generated by the first material. The second material may generate a trap within 0.45 eV from a valence band or a conduction band in silicon. The second material may generate a trap within 0.25 eV from a valence band or a conduction band in the silicon.

In yet further embodiments, the second layer has a thickness in a range of about 0.1 mm to about 1 mm. The cathode may include a supporting unit that supports the first layer and the second layer.

In other embodiments, the ion source further includes an arc chamber that defines an ionizing space. The arc chamber includes a first opening configured to be connected to a gas supplying unit and a second opening configured to extract ions generated by the ion source. The cathode is disposed between the filament and an internal area of the arc chamber at an end of the arc chamber. The second layer is positioned between the cathode and the internal area of the arc chamber and the first layer is positioned between the cathode and the second layer. The second layer may cover an upper side and lateral sides of the first layer so that the first layer is not exposed to the internal area of the arc chamber.

In further embodiments, an ion implanter includes an ion source as described above and further includes a mass analyzer configured to sort the ions generated by the ion source to provide a sorted ion beam. The ion implanter further includes an ion transmitter configured to accelerate the sorted ion beam and an end station configured to hold a substrate in a location where ions in the sorted ion beam are implanted into the substrate when the sorted ion beam is generated by the ion transmitter.

In yet other embodiments, an ion source includes an electron emission unit for emitting thermoelectrons and a cathode. The cathode includes a nonmetallic secondary electron emission unit that is heated by the thermoelectrons emitted from the electron emission unit and emits secondary electrons. The ion source may include a conductive intermediate unit that is disposed between the electron emission unit and the nonmetallic secondary electron emission unit and transmits energy obtained from the thermoelectrons emitted by the electron emission unit to the nonmetallic secondary electron emission unit.

In further embodiments, an ion source includes a cathode and a filament for emitting thermoelectrons. The cathode includes a first layer, which is heated by the thermoelectrons that are emitted from the filament, and a second layer of which at least a portion is adjacent to the first layer and which emits secondary electrons by using energy transmitted from the first layer and prevents a discharge of a material of the first layer.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic cross-sectional view illustrating an ion implanter according to some embodiments of the inventive concept;

FIG. 2 is a schematic cross-sectional view illustrating an ion source according to some embodiments of the inventive concept;

FIGS. 3A through 3D are schematic cross-sectional views illustrating cathodes according to some embodiments of the inventive concept;

FIG. 4 is a diagram illustrating energy levels of impurities in silicon;

FIG. 5 is a schematic cross-sectional view of an image sensor manufactured by using the ion implanter of FIG. 1; and

FIG. 6 is a graph illustrating a characteristic of an image sensor manufactured by using the ion implanter of FIG. 1.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the present inventive concept will only be defined by the appended claims.

The terms used in the present specification are merely used to describe particular embodiments, and are not intended to limit the inventive concept. An expression used in the singular encompasses the expression of the plural, unless it has a clearly different meaning in the context. In the present specification, it is to be understood that the terms such as “including,” “comprises/comprising” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. As used herein, the term “and/or” includes any and all combinations of one or more of the associated listed items. Expressions such as “at least one of,” when preceding a list of elements, modify the entire list of elements and do not modify the individual elements of the list.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. In the drawings, the thicknesses of layers and regions may be exaggerated for clarity. Thus, embodiments of the present inventive concept should not be construed as limited to the particular shapes of regions illustrated herein but are to include deviations in shapes that result, for example, from manufacturing. For example, right-angled etched regions may actually show rounded regions or regions having predetermined radii of curvatures. Thus, the regions illustrated in the figures are conceptual in nature and their shapes are not intended to illustrate the precise shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Like numbers refer to like elements throughout this specification. Thus, the same or similar numbers may be described with reference to other drawings even if they are neither mentioned nor described in the corresponding drawing. Also, even elements that are not denoted by reference numbers may be described with reference to other drawings.

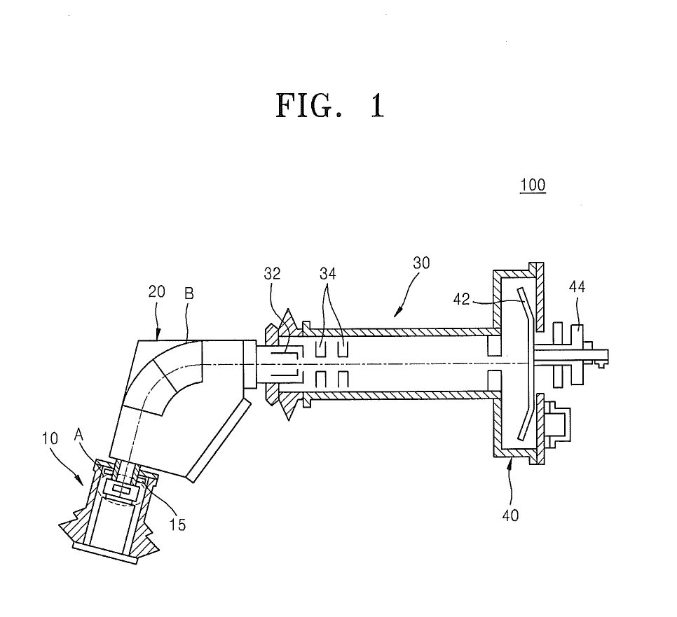

FIG. 1 is a schematic cross-sectional view illustrating an ion implanter 100 according to some embodiments of the inventive concept.

Referring to FIG. 1, the ion implanter 100 includes an ion source 10, a mass analyzer 20, an ion transmitter 30, and an end station 40. Ions that are provided from the ion source 10, which is an ion generator, may be sorted by the mass analyzer 20, and the sorted ions may be transmitted to the end station 40 by the ion transmitter 30 to implant them in a specific portion of a semiconductor substrate, such as a silicon wafer. A transmission path of the ions is illustrated by a dashed line in FIG. 1.

A source gas is supplied to the ion source 10, and ions may be generated by ionizing the supplied source gas. Electrons may be emitted from a filament of the ion source 10 by letting a high current pass through the filament and the emitted electrons may be transmitted to a cathode to generate secondary electrons. The secondary electrons that are generated in the cathode may generate ions by colliding source gas molecules. The cathode may have a double structure including a first layer and a second layer, as will be further described with reference to FIG. 2 below. Ions generated from the ion source 10 may be extracted by an ion extractor 15, and the extracted ions may have the form of an ion beam. The ion extractor 15 may include a polarity converter for converting a polarity of the extracted ions.

The mass analyzer 20 may sort predetermined ions to be implanted into a substrate from among ions constituting the ion beam by using differences in masses of ions. The mass analyzer 20 may include, for example, an analyzer magnet having a 90° bend angle and a magnetic field B, that is formed by the analyzer magnet, provides power for deflecting an ion beam, which includes impurities and various kinds of positive ions, to form a curve orbit. With respect to the intensity of the magnetic field B, ions having comparatively heavy mass may be deflected with a small angle compared to ions having a comparatively light mass. A curvature radius of such a curve orbit may be determined according to the intensity of the magnetic field B of the analyzer magnet. Thus, by adjusting the intensity of the magnetic field B of the analyzer magnet, ions having a desired mass may preferentially be selected to reach the ion transmitter 30 located in an end of the mass analyzer 20.

The ion transmitter 30 may include a quadrupole type lens 32 for focusing an ion beam 32 and an accelerator 34 for accelerating ions. Ions may have higher motive energy when a movement thereof becomes faster and may be more deeply implanted into a substrate when colliding with the surface of the substrate. The accelerator 34 may form an electric field that adds additional energy to positive ions. The positive ions are attracted to an electric field having a negative polarity when the positive ions have positive charges. An accelerating voltage is applied to form an electric field having a negative polarity, and the positive ions move faster if the intensity of the electric field is increased. On the other hand, ions sorted from the mass analyzer 20 may be decelerated if the polarity of the electric field is changed by applying a decelerating voltage.

In the end station 40, an accelerated ion beam is guided to a substrate. The end station 40 includes a supporting unit 42 for supporting one or more substrates and a driving unit 44 for rotating or moving the supporting unit 42. The one or more substrates are loaded on the supporting unit 42, and the supporting unit 42 may be rotated at high speed so that ions may be more uniformly implanted in a substrate.

The ion implanter 100 may include one or more vacuum pumps. In addition, the ion implanter 100 may further include a Faraday cup system for measuring an ion current of an ion beam and the amount of ions that are implanted into a substrate may be calculated by the Faraday cup system. Although FIG. 1 schematically illustrates only some components that may be included in the ion implanter 100, the inventive concept is not limited thereto.

FIG. 2 is a schematic cross-sectional view illustrating an ion source 1000 according to some embodiments of the inventive concept. FIG. 2 may correspond to a portion A of the ion source 10 of FIG. 1. Referring to FIG. 2, the ion source 1000 may include an arc chamber 110, a filament 120, a cathode 130 and a repeller 140. Electrons emitted from the filament 120 may transmit energy to the cathode 130, and thus, secondary electrons may be emitted from the cathode 130. The emitted secondary electrons quickly move toward the repeller 140, and may ionize a source gas by colliding with the source gas supplied to the arc chamber 110.

The arc chamber 110 may limit a space for ionizing the source gas. The arc chamber 110 may include a plurality of side walls to limit the space, and plasma may be formed therein. A first opening 112, that is connected to a gas supplying unit from which a source gas is supplied, and a second opening 114, through which generated ions are extracted, may be disposed at a first side wall 110a and a second side wall 110b, respectively, that are opposite each other in a certain direction, for example, a Y-direction, from among the plurality of side walls. The cathode 130 and the repeller 140 may be disposed adjacent to a third side wall 110c and a fourth side wall 110d, respectively, that are opposite each other in another particular direction, for example, a X-direction, from among the plurality of side walls.

A vacuum pump may be connected to the arc chamber 110 and, thus, a vacuum state thereof may be maintained. In addition, a predetermined positive voltage may be applied to the arc chamber 110 to improve ionization efficiency. In addition, the activity of electrons may be accelerated by applying an electric field to the arc chamber 110.

The filament 120 may be heated by a current applied from a power supply and then may emit thermoelectrons. The filament 120 may include nichrome or tungsten. The emitted electrons may be transmitted to the cathode 130 and, thus, the cathode may emit secondary electrons.

The cathode 130 may include a cathode cap 130a and a cathode supporting unit 130b. The cathode cap 130a may include a first layer 132 and a second layer 134. The first layer 132 may be heated by colliding with electrons that are emitted from the filament 120 and the second layer 134 may emit secondary electrons, which are generated by energy received from the first layer 132, toward the repeller 140. The cathode 130 in some embodiments may have a cylindrical shape or a square pillar shape.

The material of the first layer 132 may be different from that of the second layer 134. The first layer 132 may include a conductive material, for example, a high melting point metal such as tungsten (W) or molybdenum (Mo) that has a melting point of 2000° C. or more. The second layer 134 may include a nonmetallic material, for example, a nonmetallic material that has a melting point of 3000° C. or more. In addition, the second layer 134 may include, for example, a high melting point material that has a melting point of 3000° C. or more.

In the above ionization process of the source gas, a phenomenon in which a portion of a material constituting the cathode 130 is also ionized together with the source gas may occur. In this case, an ionized cathode material may be combined with an ionized source gas material, and then may be implanted into a substrate together with the ionized source gas material. The ionized cathode material implanted into the substrate may act as impurities that are not desired and, thus, may affect electrical characteristics of a device that is manufactured by using the substrate. In particular, if a high melting point metal is implanted together with the ionized source gas material into the substrate, a defect may be caused in the device by forming a deep-level trap in a semiconductor substrate, such as a silicon substrate. However, according to some embodiments of the inventive concept, metal ions may be limited or even prevented from being implanted into a substrate as the nonmetallic second layer 134 is disposed at the outer wall of the cathode 130.

In addition, the second layer 134 may include a material that is not well combined with the ionized source gas. That is, the material of the second layer 134 may be a material of which a possibility to be implanted into the substrate is relatively low compared to the material of the first material 132. In particular, the material of the second layer 134 may be a material of which an ionized energy is larger than that of the material of the first layer 132.

For example, if the material of the cathode 130 is tungsten (W) and the source gas is boron trifluoride (BF₃), a portion of the tungsten (W) is ionized and then is combined with positive source gas ions, and thus, positive ions such as tungsten fluoride (WFₓ⁺) may be formed. WFₓ⁺ ions may be accelerated together with other positive ions of BF₃, and then may be implanted into the substrate as stated above with reference to FIG. 1. However, the second layer 134 may include a material that has less tendency to form positive ions combined with the positive source gas ions than that of the first layer 132. That is, an ionization tendency in the material of the second layer 134 is relatively low, and a tendency to combine with the positive source gas ions may be relatively low even when the material of the second layer 134 is ionized.

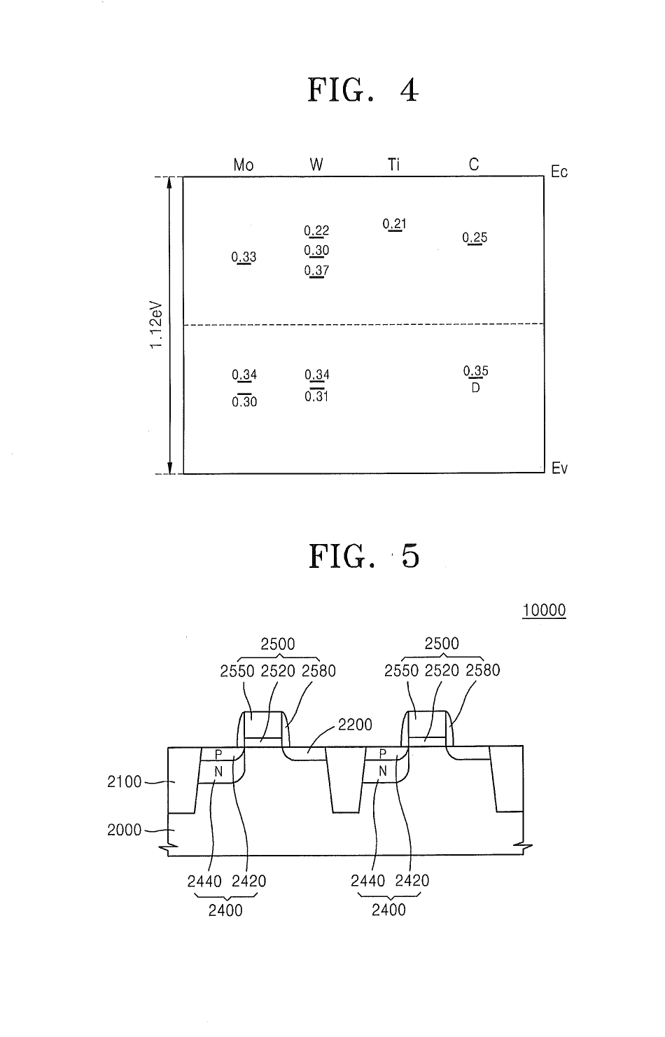

In addition, the second layer 134 may include a material that generates a shallow-level trap in silicon (Si) compared to the material of the first layer 132. For example, the second layer may include a material that generates a trap within 0.45 eV from a valence band or a conduction band in silicon (Si). In addition, the second layer 134 may include a material that generates a trap within 0.25 eV from the valence band or the conduction band in silicon (Si). Thus, although the material of the second layer 134 is implanted into the substrate, defects that are generated in a device manufactured by using the substrate may be decreased. With respect to this, a detailed description will be given with reference to FIG. 4 below. The second layer 134 may include, for example, carbon (C), black lead, or graphite. In addition, the second layer 134 may include titanium (Ti) and an oxide thereof.

The first layer 132 may have a first thickness T1, and the second layer 134 may have a second thickness T2 that is smaller than the first thickness T1. For example, the second thickness T2 may be in the range of about 0.1 mm to about 1 mm. A mechanical stability may be lowered if the second thickness T2 is relatively small, and efficiency in generating secondary electrons may be lowered if the second thickness T2 is relatively large.

The cathode supporting unit 130b may include a material having enhanced processability, and, for example, may include molybdenum (Mo).

The repeller 140 may improve ionization efficiency by repelling electrons emitted into the arc chamber 110. The repeller 140 may have a negative polarity and, thus, electrons may be repelled in the arc chamber 110 by the repeller 140, thereby improving the ionization efficiency.

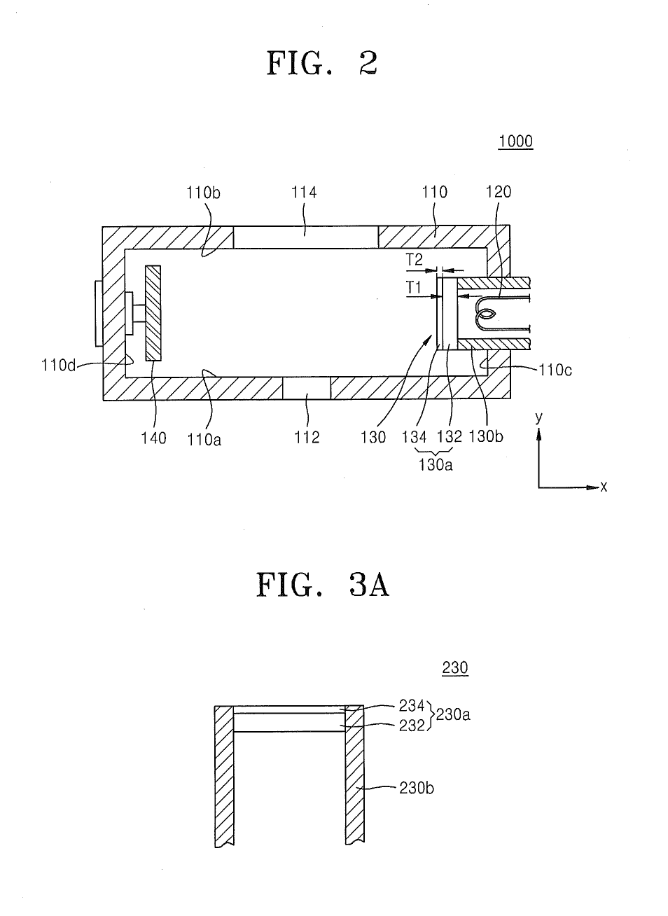

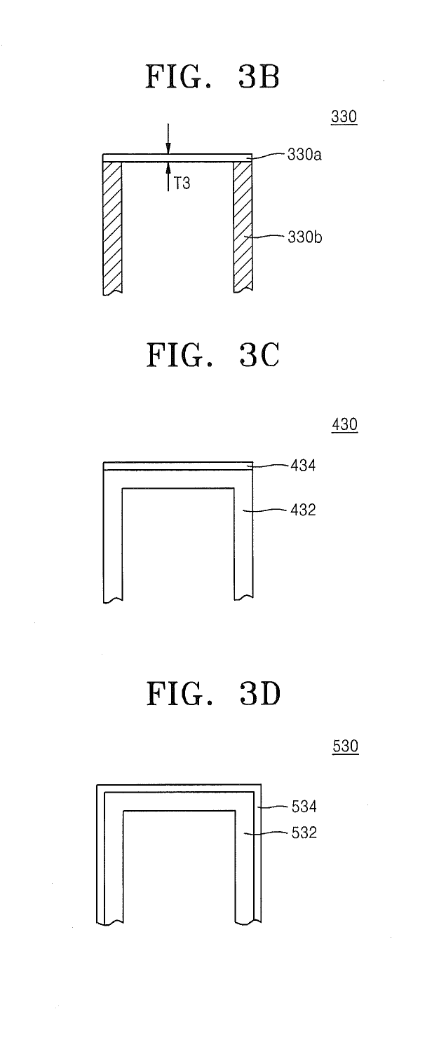

FIGS. 3A through 3D are cross-sectional views illustrating cathodes according to embodiments of the inventive concept.

Referring to FIG. 3A, a cathode 230 may include a cathode cap 230a and a cathode supporting unit 230b. The cathode cap 230a may include a first layer 232 and a second layer 234. The cathode cap 230a may correspond to the cathode cap 130a of FIG. 2, and the cathode supporting unit 230b may correspond to the cathode supporting unit 130b of FIG. 2. Thus, a description thereof will not be repeated here.

In the embodiments of FIG. 3A, unlike the embodiments of FIG. 2, the cathode supporting unit 230b may extend to cover lateral sides of the cathode cap 230a. In modified embodiments, the cathode supporting unit 230b may extend to cover only portions of the lateral sides of the cathode cap 230a. In the embodiments of FIG. 3A, as the second layer 234 is disposed on the upper side of the first layer 232, a deep-level trap may be effectively prevented from being formed due to implantation of metal ions generated from a high melting point metal of the first layer 232 into a substrate.

Referring to FIG. 3B, a cathode 330 may include a cathode cap 330a and a cathode supporting unit 330b. The cathode cap 330a may be formed of a single layer. The cathode cap 330a may emit secondary electrons by receiving energy generated through collisions with electrons that are emitted from the filament 120 of FIG. 2.

The cathode cap 330a may include a material that generates a shallow-level trap in silicon (Si) compared to the material of the first layer 232. For example, the cathode cap 330a may include carbon (C), black lead, or graphite. In addition, the cathode cap 330a may include titanium (Ti) and oxide thereof. The cathode cap 330a may have a third thickness T3. The third thickness T3 may be equal to or larger than the second thickness T2 illustrated in FIG. 2. A mechanical stability may be lowered if the third thickness T3 is relatively small, and efficiency in generating secondary electrons may be lowered if the third thickness T3 is relatively large.

The cathode supporting unit 330b may include a material having enhanced processability and, for example, may include molybdenum (Mo).

In the embodiments of FIG. 3B, as the cathode cap 330a does not include a high melting point metal, a deep-level trap may be effectively prevented from being formed due to implantation of metal ions generated from the cathode cap 330a into a substrate.

Referring to FIG. 3C, a cathode 430 may include a first layer 432 and a second layer 434. The first layer 432 may correspond to the first layer 132 of FIG. 2, and the second layer 434 may correspond to the second layer 134 of FIG. 2. Thus, a description thereof will not be repeated here.

The cathode 430 according to the embodiments of FIG. 3C, unlike the embodiments of FIG. 2, may have a structure in which the cathode supporting unit 130b and the cathode cap 130a of FIG. 2 are unified. In the embodiments of FIG. 3C, as the second layer 434 is disposed on the upper side of the first layer 432, a deep-level trap may be effectively prevented from being formed due to an implantation of metal ions generated from a high melting point metal of the first layer 432 into a substrate.

Referring to FIG. 3D, a cathode 530 may include a first layer 532 and a second layer 534. The first layer 532 may correspond to the first layer 132 of FIG. 2, and the second layer 534 may correspond to the second layer 134 of FIG. 2. Thus, a description thereof will not be repeated here.

The cathode 530 according to the embodiments of FIG. 3D, unlike the embodiments of FIG. 2, may have a structure in which the cathode supporting unit 130b and the cathode cap 130a of FIG. 2 are unified. In addition, unlike the embodiments of FIG. 3C, the second layer 534 may be disposed to surround lateral sides of the first layer 532 as well as the upper side of the first layer 532.

In the embodiments of FIG. 3D, as the second layer 534 is disposed on the upper side and the lateral sides of the first layer 532, a deep-level trap may be effectively prevented from being formed due to an implantation of metal ions generated from a high melting point metal of the first layer 532 into a substrate.

FIG. 4 is a diagram illustrating energy levels of impurities in silicon. Referring to FIG. 4, a conduction band Ec and a valance band By of the silicon are shown. The silicon has a bandgap energy of about 1.12 eV, and the center of the bandgap energy is indicated by a dotted line. Energy levels of impurity atoms in a solid may be determined by interaction due to formation of a hybrid orbit between an orbit of an impurity atom and orbits of adjacent atoms that are adjacent to the impurity atom.

The upper portion on the basis of the center of the bandgap energy corresponds to donor levels, and energy differences from the conduction band Ec are indicated in the upper portion. The lower portion on the basis of the center of the bandgap energy corresponds to acceptor levels except for the case that is shown by “D” indicating a donor level, and energy differences from the valence band Ev are indicated in the lower portion.

As illustrated in FIG. 4, impurities in the silicon may have respective specific energy levels. The energy levels of the impurities may be different according to the impurities. Molybdenum (Mo) that is used as the material of the first layer 132 of the cathode 130 (refer to FIG. 2) may have a plurality of energy levels including an acceptor level of about 0.34 eV and a donor level of about 0.33 eV. In addition, tungsten (W) that is used as the material of the first layer 132 of the cathode 130 may have a plurality of energy levels including an acceptor level of about 0.34 eV and a donor level of about 0.37 eV.

In the cathode 130 according to the embodiments of FIG. 2, carbon (C), black lead, or graphite that is used as the material of the second layer 134 facing the arc chamber 110 includes carbon (C) atoms, and the carbon (C) atoms have an acceptor level of about 0.25 eV and a donor level of about 0.35 eV (here, 0.35 eV is an energy difference from the valence band Ev). In addition, titanium (Ti) has a donor level of 0.21 eV. Thus, in the cathode 130, the second level 134 may include a material having a relatively shallow donor level compared to the first level 132. Thus, although the material of the second layer 134 is implanted into a silicon substrate, as the material of the second layer 134 forms a relatively shallow impurity level compared to molybdenum (Mo) and tungsten (W), a recombination probability is decreased and, thus, defects in electrical characteristics of a device manufactured by using a silicon substrate may be decreased.

In addition, metal ions of metals, such as molybdenum (Mo) and tungsten (W), may form various energy levels as well as energy levels indicated in FIG. 4 by combining with source gas ions. For example, a plurality of energy levels may be formed with a small energy interval if a plurality of metal ions are implanted into a silicon substrate and, thus, electrons may be easily captured or emitted.

FIG. 5 is a schematic cross-sectional view of an image sensor 10000 manufactured by using the ion implanter of FIG. 1. Referring to FIG. 5, the image sensor 10000 includes a plurality of photodiodes 2400 formed in a substrate 2000 and a plurality of transistors 2500 formed in the substrate 2000. The plurality of photodiodes 2400 and the plurality of transistors 2500 may be arranged adjacent to each other. The image sensor 10000 may be, for example, a complementary metal oxide silicon (CMOS) image sensor.

The substrate 2000 may be a semiconductor substrate such as a silicon wafer, and a device isolation layer 2100 is formed in the substrate 2000 to limit active regions.

The photodiodes 2400 receive light and then generate charges and each of the photodiodes 2400 may have a form of a PN junction diode. Each of the photodiodes 2400 may include a first well 2420 in which P-type impurities such as boron (B), gallium (Ga), indium (In), or the like are implanted and a second well 2440 in which N-type impurities such as phosphorus (P), arsenic (As), antimony (Sb), or the like are implanted.

Each of the transistors 2500 may include a gate insulation layer 2520, a gate electrode layer 2550, and a side wall spacer 2580. At a lateral side of each of the transistors 2500, a source/drain region 2200 in which impurities are doped may be formed in the substrate 2000.

Dopants may be implanted into the substrate 2000 of the image sensor 10000 by using the ion implanter as shown in FIG. 1, which includes the ion source described above with reference to FIGS. 2 through 3D. For example, the first well 2420 and the second well 2440 of each of the photodiodes 2400 may be formed by using the ion source according to an embodiment of the inventive concept.

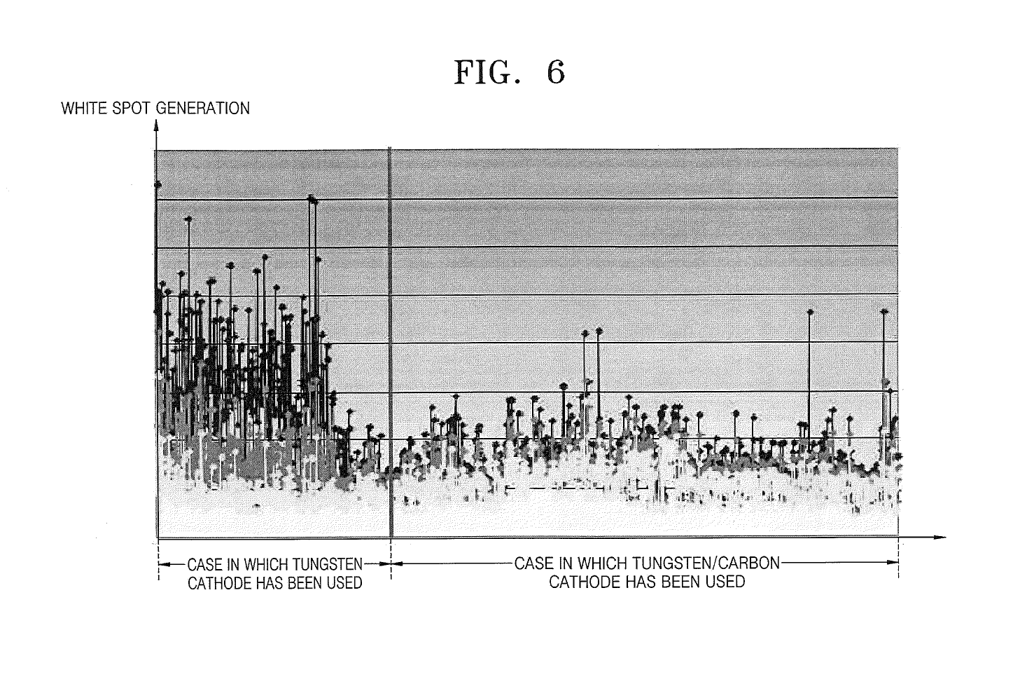

FIG. 6 is a graph illustrating a characteristic of the image sensor manufactured by using the ion implanter of FIG. 1. Referring to FIG. 6, data indicating a generation amount of white spots in the image sensor as described with reference to FIG. 5 is illustrated. The white spots are defects that are generated in the image sensor, and are a result of electrical signals being generated even if light is not incident. Data of an image sensor manufactured by using an ion implanter in which the cathode cap 130 (refer to FIG. 2) including a single layer formed of tungsten (W) is used is illustrated in the left side of the graph of FIG. 6. Data of an image sensor manufactured by using the ion implanter according to the embodiment of the inventive concept, in which the cathode cap 130 including a double layer formed of tungsten (W) of the first layer 132 and carbon C of the second layer 134 is used, is illustrated in the right side of the graph of FIG. 6.

As illustrated in FIG. 6, in the image sensor manufactured by using the ion implanter according to the embodiment of the inventive concept, less white spots are generated compared to the image sensor manufactured by using the ion implanter in which the cathode cap 130 including a single layer formed of tungsten (W) is used. According to the inventive concept, metal ions may be limited or even prevented from being implanted into a semiconductor substrate for forming an image sensor and, thus, the amount of white spots may be decreased by preventing a phenomenon in which electrons are captured and emitted due to an impurity level that is formed by the metal ions.

As described above, embodiments of the inventive concept provide an ion source for preventing electrical characteristics from deteriorating due to impurities. Embodiments of the inventive concept also provide an ion implanter for preventing electrical characteristics from deteriorating due to impurities.

According to an aspect of the inventive concept, there is provided an ion source including: a filament for emitting thermoelectrons; and a cathode comprising a first layer, which is heated by the thermoelectrons that are emitted from the filament, and a second layer of which at least a portion is adjacent to the first layer and which emits secondary electrons by using energy transmitted from the first layer and prevents a discharge of a material of the first layer.

The second layer may include a material that is different from that of the first layer.

The first layer may include a metal, and the second layer may include a nonmetallic material.

The second layer may include carbon, black lead, graphite, or a high melting point material.

The second layer may include a nonmetallic material that has a melting point of 3000° or more.

The ion second layer may include carbon, black lead, or graphite.

The first layer may include a high melting point metal that has a melting point of 2000° C. or more.

Ionization energy of a material of the second layer may be larger than that of the material of the first layer.

The second layer may include a material that generates a shallow-level trap in silicon compared to a material of the first layer.

The second layer may include a material that generates a trap within 0.45 eV from a valence band or a conduction band in silicon.

The second layer may include a material that generates a trap within 0.25 eV from a valence band or a conduction band in the silicon.

The second layer may have a thickness in a range of about 0.1 mm to about 1 mm.

The cathode may further include a supporting unit for supporting the first layer and the second layer.

The ion source may further include an arc chamber that provides an ionizing space and is connected to a gas supplying unit and an ion beam path, wherein the cathode is disposed between the filament and an internal area of the arc chamber at one end of the arc chamber.

The second layer may cover upper side and lateral sides of the first layer so as not to expose the first layer to the internal area of the arc chamber.

According to another aspect of the inventive concept, there is provided an ion implanter including: the ion source; a mass analyzer for sorting ion beams extracted from the ion source; an ion transmitter for accelerating the sorted ion beams; and an end station in which a substrate, into which the sorted ion beams are implanted, is disposed.

According to another aspect of the inventive concept, there is provided an ion source including: an electron emission unit for emitting thermoelectrons; and a cathode comprising a nonmetallic secondary electron emission unit that is heated by the thermoelectrons emitted from the electron emission unit and emits secondary electrons.

The ion source may further include a conductive intermediate unit that is disposed between the electron emission unit and the nonmetallic secondary electron emission unit and transmits energy obtained from the thermoelectrons emitted by the electron emission unit to the nonmetallic secondary electron emission unit.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. An ion source comprising:
a filament configured to emit thermoelectrons; and
a cathode having a first side proximate the filament and a second side opposite the first side, the cathode comprising
a first layer comprising a first material on the first side of the cathode, and
a second layer on the second side of the cathode with the first layer between the filament and the second side, wherein the second layer is configured to limit discharge of the first material of the first layer from the ion source when the filament emits themoelectrons to generate ions from the ion source.

2. The ion source of claim 1, wherein the first layer is heated by the thermoelectrons that are emitted from the filament and the second layer emits secondary electrons responsive to energy transmitted from the first layer when the first layer is heated by the thermoelectrons.

3. The ion source of claim 1, wherein the second layer comprises a second material that is different from the first material.

4. The ion source of claim 3, wherein the first material is a metal and the second material is a nonmetallic material.

5. The ion source of claim 4, wherein the second material includes at least one of carbon, black lead, graphite and a high melting point material.

6. The ion source of claim 5, wherein the second material includes at least one of carbon, black lead and graphite.

7. The ion source of claim 3, wherein the second material is a nonmetallic material that has a melting point of at least 3000° C.

8. The ion source of claim 7, wherein the first material is a high melting point metal that has a melting point of at least 2000° C.

9. The ion source of claim 3, wherein an ionization energy of the second material is larger than an ionization energy of the first material.

10. The ion source of claim 3, wherein the second material is a material that generates a shallow-level trap in silicon compared to a trap generated by the first material.

11. The ion source of claim 10, wherein the second material generates a trap within 0.45 eV from a valence band or a conduction band in silicon.

12. The ion source of claim 10, wherein the second material generates a trap within 0.25 eV from a valence band or a conduction band in the silicon.

13. The ion source of claim 1, wherein the second layer has a thickness in a range of about 0.1 mm to about 1 mm.

14. The ion source of claim 1, wherein the cathode further comprises a supporting unit that supports the first layer and the second layer.

15. The ion source of claim 1, further comprising an arc chamber that defines an ionizing space and includes a first opening configured to be connected to a gas supplying unit and a second opening configured to extract ions generated by the ion source, wherein the cathode is disposed between the filament and an internal area of the arc chamber at an end of the arc chamber and the second layer is positioned between the cathode and the internal area of the arc chamber and the first layer is positioned between the cathode and the second layer.

16. The ion source of claim 15, wherein the second layer covers an upper side and lateral sides of the first layer so that the first layer is not exposed to the internal area of the arc chamber.

17. An ion implanter including the ion source of claim 1 and further comprising:
a mass analyzer configured to sort the ions generated by the ion source to provide a sorted ion beam;
an ion transmitter configured to accelerate the sorted ion beam; and
an end station configured to hold a substrate in a location where ions in the sorted ion beam are implanted into the substrate when the sorted ion beam is generated by the ion transmitter.

18. An ion source comprising:
an electron emission unit for emitting thermoelectrons; and
a cathode comprising a nonmetallic secondary electron emission unit that is heated by the thermoelectrons emitted from the electron emission unit and emits secondary electrons.

19. The ion source of claim 18, further comprising a conductive intermediate unit that is disposed between the electron emission unit and the nonmetallic secondary electron emission unit and transmits energy obtained from the thermoelectrons emitted by the electron emission unit to the nonmetallic secondary electron emission unit.

20. An ion source comprising:
a filament that emits thermoelectrons; and
a cathode comprising a first layer, which is heated by the thermoelectrons that are emitted from the filament, and a second layer of which at least a portion is adjacent to the first layer and which emits secondary electrons by using energy transmitted from the first layer and prevents a discharge of a material of the first layer.
